(19) United States
(12) Patent Application Publication
(10) Pub. No.: US 2007/0129905 A1
(43) Pub. Date: Jun. 7, 2007

(54) DETERMINING THE VOLUME OF FUEL DISPENSED FROM A FUEL DISPENSING UNIT

(75) Inventors: Bengt I. Larsson, Skivarp (SE); Per Kristiansson, Arlov (SE)

Correspondence Address: FISH & RICHARDSON P.C., P.O. BOX 1022, MINNEAPOLIS, MN, 55440-1022, US

(73) Assignee: DRESSER, INC., Addison, TX (US)

(21) Appl. No.: 11/561,271

(22) Filed: Nov. 17, 2006

(30) Foreign Application Priority Data
Nov. 25, 2005 (EP) EP 05111282.9

(51) Int. Cl. G01F 25/00

(52) U.S. Cl. 702/100

(57) ABSTRACT

In some implementations, an apparatus for determining the volume of fuel dispensed from a fuel dispensing unit has a measuring device configured to generate signals corresponding to a fuel flow rate (Q) when dispensing fuel and a correction unit for correcting the signals by elements of correction data associated with the apparatus and stored in a memory. Backup correction data associated with an apparatus are stored, for the purpose of data retrieval, in a backup memory included in the fuel dispensing unit.

### CLAIM OF PRIORITY

This application claims priority under 35 U.S.C. §119 to European Patent Application Serial No. 05111282.9, filed on Nov. 25, 2005, the entire contents of which are hereby incorporated by reference.

### TECHNICAL FIELD

The present disclosure relates to fuel dispensers and, more particularly, to determining the volume of fuel dispensed from a fuel dispensing unit.

### BACKGROUND

There are several existing devices for determining the volume of fuel being dispensed from a fuel dispensing unit at a petrol station. Such a volume determining device must be able to carry out volume determination with a predetermined minimum accuracy for different flow rates when dispensing fuel and for different volumes of fuel dispensed. To achieve this accuracy, the device must be adjusted/calibrated in manufacture and subsequently at regular intervals.

U.S. Pat. No. 6,721,669 discloses a device for measuring the volumetric flow of fuel in a fuel dispensing unit. The device consists of a screw spindle counter in the form of two intermeshing wormdrive screw spindles that rotate when fuel passes through the screw spindle counter. One of the spindles carries a magnet, and rotation of the magnet as a result of the rotation of the screw spindle causes the generation of pulse-shaped measurement signals from a sensor element which cooperates with the magnet. The screw spindle structure often results in non-linearity between the measurement signal and the actual volume flow. Also, due to manufacturing tolerances, screw spindle counters of the same structure generate different measurement signal frequencies or signal durations, even if the same flow of fuel is passing through the screw spindle counters. In addition, wear continuously changes the relationship between the measurement signal and the actual volume flow.

To achieve measurement accuracy, the signals are fed to a measuring transducer where signal correction takes place, whereby a correction factor depending on the fuel flow rate to be measured is used. For this purpose, the measurement signal frequency is determined as a measure of the flow rate. Relating to a plurality of measurement signal frequency values, corresponding correction factors are stored in a table within the transducer. Using the appropriate correction factor for the corresponding cycle frequency, the transducer derives counter signals corresponding to the actual flow of fuel and feeds these to a fuel volume counter. The correction data is generated and stored when calibrating the screw spindle counter.

WO 98/20307 discloses another device for measuring the volumetric flow of fuel in a fuel dispensing unit. This device comprises pistons being displaced when fuel passes through the device. A magnet is associated with the pistons and rotates when the pistons are displaced, and this rotation causes the generation of pulse-shaped measurement signals from a sensor element which cooperates with the magnet. The device has a structure where magnet rotation frequency is substantially constant, independent of the fuel flow rate passing through the device, resulting in a substantially linear relationship between the measurement signal and the actual volume flow.

However, due to manufacturing tolerances and continuous water, piston displacement devices of the same structure have different relationships between the measurement signal and the actual volume flow. To achieve measurement accuracy, the signals are fed to a measuring transducer where signal correction takes place. The transducer derives counter signals by applying fix correction factors and feeds the counter signals to a fuel volume counter. Calibration of the device is carried out at regular intervals to update the correction factors.

A problem associated with the above devices is that loss of correction data results in the fuel dispensing unit being unable to deliver a correct amount of fuel. This loss of data may occur due to software failures, memory device failure and other system failures. Moreover, when a malfunctioning transducer is replaced with a new one, the new transducer does not have the appropriate correction data in its memory, since correction data is individual for every fuel flow measuring unit. To load correction data in a transducer, a common method is to connect a portable PC to a signal input of the transducer and to transfer the appropriate correction data from the PC to the transducer. This elements that correction data for all flow measuring units being manufactured must be stored on, for example, a data server belonging to the manufacturer of the measuring unit. In addition, when a measuring unit is calibrated, the resulting updated correction data must be stored on a data server.

This is a cumbersome and labor intensive process which also involves electrical devices (the PC) with voltages being undesirable high in a close vicinity of a fuel dispensing unit, were highly flammable gases are present.

### SUMMARY

It is an object of the present disclosure to provide an improvement of the above techniques and prior art.

In some implementations, a particular objective is to provide an apparatus for determining the volume of fuel being dispensed from a fuel dispensing unit, which apparatus is simple in structure, offers low production costs, high operational time and/or low maintenance.

In some implementations, a particular object is to minimize costs and/or problems associated with loss or transfer of correction data for a measuring apparatus determining the flow of fuel and/or the volume of fuel being dispensed.

These objects may be achieved by an apparatus, a system, and/or a method having the features defined in claims 1 and 14. Additional implementations of the apparatus are defined in the subclaims.

The disclosure thus includes an apparatus for determining the volume of fuel dispensed from a fuel dispensing unit. The apparatus may comprise a measuring device configured to generate signals corresponding to a fuel flow rate when dispensing fuel, and a correction unit for correcting the signals by elements of correction data associated with the apparatus and stored in a memory. Backup correction data associated with an apparatus may be stored, for the purpose of data retrieval, in a backup memory included in the fuel dispensing unit.

In some implementations, a general advantage of the apparatus according to the disclosure is that it may be very easy to recover correction data lost in the memory of an apparatus. By storing the correction data in a backup memory, there may also be increased data protection in case of fuel dispensing unit system failure. Furthermore, the need for an external backup server may be substantially reduced, and a service technician maintaining the apparatus and in need of missing correction data, may not have to retrieve the data from a remotely positioned data source. It should be noted that the backup correction data may be associated with any apparatus for determining the volume of fuel dispensed from a fuel dispensing unit. However, as further elucidated below, the backup correction data is often associated with another apparatus according to the disclosure, but may also be associated with the apparatus having the backup memory storing the backup correction data.

In some implementations, the backup memory may be arranged in the correction unit. This may be highly advantageous since present correction units may be easily modified to incorporate a backup memory having backup correction data. Another advantage may be that present correction units comprise elements for sending and receiving data to a memory of the correction unit, thereby facilitating the implementation of data communication with a backup memory.

The apparatus may further comprise a barrier device for explosion protection, said barrier device disposed between the apparatus and a fuel dispensing unit controller arranged in the fuel dispensing unit, thereby serving as an explosive protection barrier for flammable fuel.

The backup memory may be arranged in the barrier device. This may also be highly advantageous since present barrier devices may be easily modified to incorporate a backup memory having backup correction data.

The backup correction data may in some versions be a copy of the correction data, meaning the backup correction data may be associated with the apparatus comprising the backup memory having the backup data. This configuration may allow very convenient transfer of correction data, from the backup memory of an apparatus to the memory of the same apparatus, when correction data is lost in the memory.

The backup correction data may also be associated with a further apparatus for determining the volume of fuel dispensed from another fuel dispensing unit. This association may be advantageous since correction data may be recovered from a first apparatus according to the disclosure, and may then be stored in a second apparatus having lost its correction data. The second apparatus may also be an apparatus for determining the volume of fuel dispensed from a fuel dispensing unit, and is often an apparatus according to the disclosure.

Both apparatuses may be arranged within the same fuel dispensing unit. This may allow data to be recovered for an apparatus, even if all data in all memories of the apparatus have been lost. For the purpose of identifying which apparatus the correction data belongs to, an identifier, such as apparatus manufacture number, associated with a specific apparatus, may be stored together with the backup correction data for the same apparatus. As further described below, the identifier and corresponding correction data may also be associated with the measuring device of an apparatus.

Of course, in case of a plurality of apparatuses according to the disclosure, multiple combinations of backup correction data storage may be possible. For example, an apparatus according to the disclosure may store backup correction data for several of said apparatuses. Furthermore, the correction data for the second apparatus above could be stored in any of, for example, a memory of the first apparatus, a memory of a correction unit belonging to the first apparatus, or a memory of an explosion barrier device belonging to the first apparatus.

The memory and the backup memory may consist of individual memory units, but may also consist of data sections of the same memory unit, thereby facilitating versatile implementation of the correction data.

The correction data is often in the form of a table having a plurality of values corresponding to a plurality of measurement signals. Typically, the measurement signals may be pulse frequency signals or pulse duration signals, and the measurement signals may each be associated with at least one correction value. In other words, the correction data may be in the form of a table having a plurality of values corresponding to a plurality of fuel flow rate values. This gives the advantage of fast and flexible data retrieval and storage.

In further detail, the correction data may be associated with the measuring device of the apparatus it belongs to, and the backup correction data may be associated with a measuring device included in an apparatus for determining the volume of fuel dispensed from a fuel dispensing unit. This is practical since, more specifically, it is typically the structure of the measuring device that causes the need of applying correction data.

According to another aspect of the disclosure, a fuel dispensing unit comprising at least one apparatus according to the disclosure is provided. The fuel dispensing unit may also comprise a plurality of apparatuses according to the disclosure, wherein each apparatus has its associated correction data stored in a memory associated with another apparatus.

In another aspect of the disclosure, there is also provided a method having the features defined in appended claim 14.

The fuel dispensing unit and the method according to the disclosure may both have the same advantages as the previously discussed apparatus according to the disclosure. All various memory and data combinations discussed for the apparatus may also be implemented for the fuel dispensing unit and the method according to the disclosure.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram of an apparatus for determining the volume of dispensed fuel in accordance with one implementation of the present disclosure.

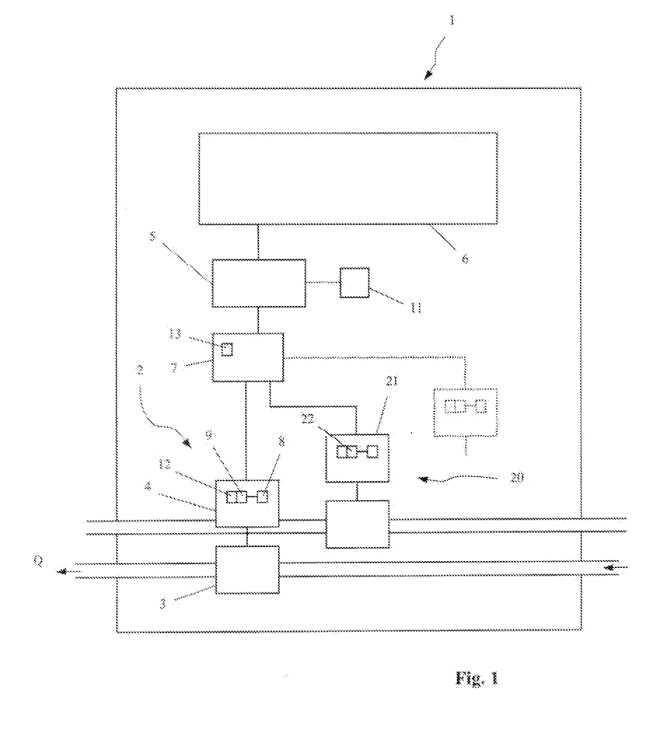

### DETAILED DESCRIPTION

The figure shows schematically how an apparatus 2 for determining the volume of fuel dispensed from a fuel dispensing unit 1 may be composed and arranged. The apparatus 2 may be arranged within the dispensing unit 1 and comprise a measuring device 3 with a screw spindle counter (not shown) adapted to generate electronic pulses corresponding to the volume flow rate Q when dispensing fuel from the dispensing unit 1. The measuring device 3 may be arranged between a pump device for pumping fuel from a fuel tank and a nozzle for dispensing fuel to a vehicle (not shown). The pulses may be fed to a correction unit 4 having a correction controller 8 and a memory 9 where correction data is stored. The correction data may be in the form of a table and may contain a plurality of correction factors relating to different pulse durations and/or pulse repetition frequencies of measurement signals.

The correction controller 8 analyses pulses delivered by the measuring device 3 in respect of their duration or repetition frequency, and in this way often determines the rotational frequency of the screw spindles. Based on the spindle rotation frequency, the correction controller 8 may call a correction factor from the correction data and may apply a weighted number of pulses to a specific number of pulses received, so that counter pulses may be generated corresponding to the actual volume of fuel flowing through the measuring device 3.

This correction process may address a non-linear relationship between flow rate Q and spindle rotation frequency. Also, due to manufacturing tolerances, measuring devices of the same structure m ay generate different measurement signals frequencies or signals durations, even if the same flow of fuel is passing through all measuring devices, may result in a need for pulse correction. In addition, wear may continuously change the relationship between the measurement signal and the actual volume flow, which may also results in a need for pulse correction.

It should be noted that the correction data may be updated at regular intervals by calibration of the apparatus. The counter pulses (corrected pulses) may be transferred to a fuel dispensing unit controller 5 which converts the counter pulses to a volume of dispensed fuel and a corresponding fuel cost, which volume and cost may be displayed on the fuel dispensing unit head 6.

Since certain electric voltages are present in the fuel dispensing unit controller 5, an EExi barrier device 7 may be arranged between the fuel dispensing unit controller 5 and the correction unit 4 in order to provide explosion protection for flammable fuel in, for example, the measuring device 3. The EExi barrier device 7 may be an electronic device having a protective function in potentially explosive atmospheres, and its technical requirements may be stipulated in Direction 94/9/EC (ATEX). The EExi barrier device 7 may also be a barrier device according to CENELEC standards, or according to any other suitable standard for providing protection. Instead of an EExi barrier device 7, an EExd, EExp, EExn or EExm barrier device may be used, or any other device providing similar functionality.

The correction data stored in the memory 9 are also stored as backup correction data in, in any combination of i) a backup memory 11 of the fuel dispensing unit 1, ii) a backup memory 12 of the correction unit 4, iii) a memory 13 of the EExi barrier device 7, and iv) a memory 22 of a second apparatus 20 according to the disclosure. This storage of backup correction data is preferably con-ducted for all apparatuses present in the fuel dispensing unit 1. The dashed connection between the fuel dispensing unit controller 5 and the backup memory 11 of the fuel dispensing unit 1 may represent the fact that the backup memory 11 may be located anywhere within the fuel dispensing unit 1 and may be connected to any unit capable of data communication as long as the backup correction data may be transferred from the backup memory 11 to the correction unit 4. It should be noted that a backup memory 11 according to the disclosure is typically not a separate physical unit, but may be a part of an existing memory device.

Generally, the backup correction data may be stored only in the memory 22 of the second apparatus 20, which memory is often located in the correction unit 21 of the second apparatus 20. Of course, the second apparatus 20 may also have its own associated correction data stored in a memory often arranged in its correction unit 21.

When manufacturing a fuel dispensing unit, typically two to six apparatuses according to the disclosure are arranged inside the fuel dispensing unit. All of said apparatuses may be, via an EExi barrier or the like, connected to the fuel dispensing unit controller and may have their associated correction data stored in the memory of the respective correction unit. Furthermore, each apparatus may have, in the respective correction unit, a backup memory storing a backup of correction data associated with another of the apparatuses in the fuel dispensing unit.

Correction data may be stored in the memories by any known suitable elements for data communication and storage. When any of the apparatuses or correction units looses its associated correction data, or when the correction unit is replaced by a new one, a service technician may readily transfer backup correction data from a neighboring apparatus to the apparatus or correction unit without the data or being the replacement part. The transfer may be accomplished by known elements for suitable data transfer, for example, by a PC or by the fuel dispensing unit controller, via conventional elements for data signal transfer.

An identifier may also be stored with each correction data, hence making it possible to identify which apparatus or measuring device the correction data belongs to. Typically, memory and backup memory are located on the same memory unit, thereby having different memory areas on the memory unit.

The memories are typically ROM, RAM, EPROM, EEPROM, OTP EPROM, and/or flash memory devices or any other suitable memory device. The memory may also be replaced by a new memory having correction data stored prior to its mounting in place.

The correction data may not be in the form of a table, but may also be a mathematical function deriving correction factor(s) from, for example, pulse repetition frequencies.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An apparatus for determining the volume of fuel dispensed from a fuel dispensing unit, comprising:
a measuring device configured to generate signals corresponding to a fuel flow rate (Q) when dispensing fuel; and
a correction unit for correcting the signals by elements of correction data associated with the apparatus and stored in a memory, wherein backup correction data associated with an apparatus are stored, for the purpose of data retrieval, in a backup memory included in the fuel dispensing unit.

2. The apparatus of claim 1, wherein the backup memory is arranged in the correction unit.

3. The apparatus of claim 1, further comprising:
a barrier device for explosion protection, said barrier device disposed between the apparatus; and
a fuel dispensing unit controller arranged in the fuel dispensing unit.

4. The apparatus of claim 3, wherein the backup memory is arranged in the barrier device.

5. The apparatus of claim 1, wherein the backup correction data is a copy of the correction data.

6. The apparatus according to claim 1, wherein the backup correction data is associated with a further apparatus for determining the volume of fuel dispensed from another fuel dispensing unit.

7. The apparatus of claim 6, wherein both apparatuses are arranged within the same fuel dispensing unit.

8. The apparatus of claim 1, wherein the memory and the backup memory are parts of the same memory unit.

9. The apparatus of claim 1, wherein the correction data is in the form of a table having a plurality of values corresponding to a plurality of measurement signals.

10. The apparatus of claim 1, wherein the correction data is associated with the measuring device.

11. The apparatus of claim 1, wherein the backup correction data is associated with a measuring device of an apparatus.

12. The apparatus of claim 1, wherein the apparatus is integrated into fuel dispensing unit.

13. A system, comprising:
a plurality of fuel dispensing units, each fuel dispensing unit comprising:
a measuring device configured to generate signals corresponding to a fuel flow rate (Q) when dispensing fuel; and
a correction unit for correcting the signals by elements of correction data associated with the apparatus and stored in a memory, wherein backup correction data associated with an apparatus are stored, for the purpose of data retrieval, in a backup memory included in a different fuel dispensing unit.

14. A method of transferring correction data to an apparatus for determining the volume of fuel dispensed from a fuel dispensing unit, said apparatus comprising a measuring device configured to generate signals corresponding to a fuel flow rate (Q) when dispensing fuel, and a correction unit for correcting the signals by elements of the correction data stored in a memory of the correction unit, the method comprising:
sending signals to the correction unit indicating that correction data is to be loaded,
retrieving the correction data at least one of:
a backup memory arranged in the fuel dispensing unit;
a backup memory arranged in the correction unit;
a memory arranged in a barrier device for explosion protection, said barrier device disposed between the apparatus and a fuel dispensing unit controller arranged in the fuel dispensing unit; or
a memory arranged in a second correction unit associated with a second apparatus for determining the volume of fuel dispensed from a fuel dispensing unit; and
storing the retrieved correction data in the memory of the correction unit.
